(19) United States
(12) Patent Application Publication
(10) Pub. No.: US 2016/0189169 A1
(43) Pub. Date: Jun. 30, 2016

(54) System and Method for Detecting Counterfeit Products

(71) Applicants: Salim Shah, Vienna, VA (US); Zacharia Shah, Vienna, VA (US)

(72) Inventors: Salim Shah, Vienna, VA (US); Zacharia Shah, Vienna, VA (US)

(21) Appl. No.: 14/985,857

(22) Filed: Dec. 31, 2015

Related U.S. Application Data
(60) Provisional application No. 62/099,034, filed on Dec. 31, 2014.

(51) Int. Cl. G06Q 30/00; G06K 7/14

(52) U.S. Cl. CPC G06Q 30/0185; G06K 7/1408

(57) ABSTRACT

Systems and methods are provided for determining counterfeit products. The systems may comprise a bar code scanner and a product database server, wherein the bar code scanner is adapted to communicate with the product database server, the product database server containing bar code data. The bar code data scanner may be included in a mobile application on a mobile device. Methods may comprise: assigning bar code data to a first product; storing the bar code data of the first product to a product database server; scanning with a mobile application bar code data of a second product in a marketplace; sending the data associated with the scanned bar code data of the second product to the product database; and determining if the bar code data of the first product in the product database server matches the scanned bar code data of the second product in the marketplace.

### FIELD OF THE INVENTION

The invention is directed to systems and methods for detecting counterfeit products. More specifically, the invention is directed to a system that allows a mobile application to communicate with a product database server to determine if the server possesses the correct product identifier (such as a barcode). The invention is also directed to a method that includes obtaining (such as by scanning) a product identifier, encrypting data associated with the obtained product identifier and sending the data to a database to determine if the database possesses the obtained product identifier.

### BACKGROUND OF THE INVENTION

Questions for any customer involved in a purchasing process may be: is this product the real thing? Is the product what the product label says it is? Is this product an original product or a knock-off copy of the original product? For most, if not all, products available on the market, there is no easy and straightforward way to determine, such as by visual inspection, if a product is genuine. The product's labeling or packaging is generally the only indication of its origins.

As is well-known, many products available on the market today may be counterfeited and sold for profit by counterfeiting parties. Depending on the type of product, a counterfeited version thereof may be prevalent in the market place. Prevalent counterfeited products may include, but are certainly not limited to, automotive parts, fashion products such as designer handbags and pharmaceuticals. In many cases, a product's labeling or packaging, along with the product, may be counterfeited.

Counterfeiting of products can be highly lucrative due to high demand and low production costs. The absence of deterrent legislation in many jurisdictions, coupled with difficulty of enforcement, also encourages counterfeiting since there is little, if any, fear of the counterfeiter being apprehended and prosecuted. Also, when prices of retail products are high, there is a greater incentive for the purchasing party to seek similar products outside the conventional retail system. Poverty, then, may play a key role in driving the demand for counterfeit products.

While purchasing a counterfeit designer handbag may be detrimental to the designer and purchasing party, such a purchase generally does not lead to adverse health effects to the designer and/or purchasing party. However, it can absolutely be envisioned that the purchase of counterfeit pharmaceuticals may lead to adverse health effects to the purchasing party, including death.

Counterfeiting is a growing global problem, particularly counterfeit products that can lead to adverse health effects. With respect to pharmaceuticals, and according to the United States FDA, counterfeit pharmaceuticals comprise more than 10% of the global pharmaceutical market and are present in both developed and developing countries. It is estimated that up to 25% of the medicines consumed in developing countries are counterfeit or substandard (Ref). Counterfeit pharmaceuticals are more prevalent in countries with: 1) weak regulation control; 2) weak enforcement; 3) scarcity and/or erratic supply of basic pharmaceuticals; 4) unregulated markets; 5) and/or unaffordable prices. One of the most counterfeited drugs today is Viagra, which is sold extensively via the Internet in industrialized countries (Ref). A World Health Organization (WHO) survey of counterfeit medicine reports from 20 countries between January 1999 and October 2000 found that 60% of counterfeit pharmaceutical cases occurred in developing countries and 40% in developed countries. A recent study in The Lancet concluded that up to 40% of artusenate products (the best medicine to combat resistant malaria today) contain no active ingredients and therefore have no therapeutic benefits (Ref).

Counterfeit pharmaceuticals may be deliberately and fraudulently mislabeled with respect to identity and/or source. This applies to both branded and generic drug products. Counterfeit pharmaceuticals may include products with the correct ingredients but fake packaging, or with the wrong ingredients, or without active ingredients or with insufficient active ingredients. In developed countries, the most frequently counterfeited pharmaceuticals are new, expensive lifestyle medicines, such as hormones, steroids and antihistamines. In developing countries, the most counterfeited medicines are those used to treat life-threatening conditions such as malaria, tuberculosis and HIV/AIDS.

Regular use of counterfeit pharmaceuticals may lead to therapeutic failure or drug resistance, and in many cases it leads to death. For example, during the meningitis epidemic in Niger in 1995, over 50,000 people were inoculated with fake vaccines, received as a gift from a country which thought they were safe. This resulted in about 2,500 deaths (Ref). In another example, the consumption of paracetamol cough syrup prepared with diethylene glycol (a toxic chemical used in antifreeze) led to 89 deaths in Haiti in 1995 and 30 infant deaths in India in 1998 (Ref). Out the approximately one million deaths that occur annually from malaria, as many as 200,000 could be avoided if the medicines available were not counterfeited.

Because of a lack of regulation and enforcement, the quality, safety and efficacy of both imported and locally manufactured pharmaceuticals in many developing countries cannot be guaranteed. Subsequently, smuggling and illegal importation of pharmaceuticals are often rife. Substandard and counterfeit pharmaceuticals are then not only sold in these countries but also exported or re-exported. The situation is exacerbated by the fact that pharmaceuticals exported from many industrialized countries are not regulated to the same level as those domestically consumed, while export of pharmaceuticals to developing countries via free trade zones is increasing. Re-labeling of products to mask details of their origin is also known to occur.

Legislation forms the basis for pharmaceutical regulation. Pharmaceuticals need to be safe and effective in order to achieve desired therapeutic effects. Ensuring the desired therapeutic effects requires the creation of competent pharmaceutical regulatory authorities with the necessary human and other resources to control the manufacture, importation, distribution and sale of genuine pharmaceutical products. However, institutional corruption and criminal activity may undermine such efforts. Government enforcement may be further undermined due to lack of intersectional cooperation between regulatory authorities, police, customs services and the judiciary, thereby diminishing an ability to effectively control the pharmaceutical market. Moreover, globalization has led to an increase in counterfeiting due in part to reduced trade barriers between countries. Furthermore, policy-makers believe that pharmaceutical regulation represents an unnecessary barrier to trade and should be reduced to a minimum. Pharmaceuticals, however, cannot be considered a standard commodity since consumers and prescribers are unable to assess their quality, safety and efficacy and the results can be harmful to a patient's health, even fatal.

There are several national and international laws and regulations specifically enacted to protect customers from counterfeited products. However, like many other laws, the enforcement of such laws and prosecution of counterfeiters is less then optimal. Moreover, in law enforcement schemes to enforce such anti-counterfeiting laws, customers are generally passive parties and may find themselves at the mercy of the enforcing agencies.

Thus, there is a need for a purchaser to quickly and accurately determine if a product is a genuine product. The systems and methods provided herein offer tools to meet such a need by empowering customers to determine directly whether a product is counterfeit or not. The systems and methods provided herein minimize the reliance on law enforcement or other entities for such a determination. The systems and methods provided herein also add social value because in certain cases (such as those related to pharmaceuticals) they can prevent death and save life.

### SUMMARY OF THE INVENTION

To overcome the aforementioned problems associated with counterfeited products, hereby is described systems and method for determining counterfeit products.

The systems may comprise: a bar code data scanner and a product database server, wherein the bar code data scanner is adapted to communicate with the product database server, the product database server containing bar code data. In embodiments, the bar code data scanner is included in a mobile application on a mobile device, the mobile application adapted for at least one of scanning bar code data, encrypting the data, sending the encrypted data to the product database server, receiving information from the product database server which indicates whether the database server contains the scanned bar code data, providing mobile device location information, providing mobile device information and providing mobile device owner information. In embodiments, the bar code data of the first product is unique bar code data and/or randomly generated bar code data.

In embodiments, systems may also include: a first network comprising an application database server that accepts requests from the mobile application and is able to decrypt the encrypted data sent by the mobile application; a first firewall allowing traffic from the internet to the first network; a second network comprising the product database server and optionally comprising a data storage database server; and a second firewall allowing traffic from the application server to the product database and/or the optional data storage database server.

In embodiments, the product database server is adapted for receiving, storing, searching and sorting bar code data, receiving at least one signal from the mobile application, sending at least one signal to the mobile application, tagging the scanned bar code data as scanned, and moving the scanned bar code data to a different file.

In embodiments, the data storage database server, the data storage database adapted for receiving, storing, searching and sorting the mobile device location information, receiving, storing, searching and sorting the mobile device information and receiving, storing, searching and sorting the mobile device owner information.

In embodiments, the second firewall is adapted to separate bar code data from the mobile device information and send the bar code data to the product database server and send the mobile device information to the data storage database server.

The methods may comprise: assigning bar code data to a first product; storing the bar code data of the first product to a product database server; scanning with a mobile application bar code data of a second product in a marketplace; sending the data associated with the scanned bar code data of the second product to the product database; determining if the bar code data of the first product in the product database server matches the scanned bar code data of the second product in the marketplace. In embodiments, the methods may also include: generating the bar code data for the first product; encrypting the scanned bar code data of the second product; decrypting the scanned bar code data of the second product; and outputting a signal to the mobile application as to whether the bar code data of the first product in the product database server matches the scanned bar code data of the second product in the marketplace.

In embodiments, sending the scanned bar code data of the second product to the product database server comprises sending the data over the internet. In embodiments, the outputting comprises binary information in the form of yes and no or in colors that correspond to yes and no.

### BRIEF DESCRIPTION OF THE FIGURES

FIG. 1 shows a schematic of an embodiment of the system.

FIG. 2 shows a schematic of an embodiment of the system.

### DETAILED DESCRIPTION OF THE INVENTION

The invention now will be described more fully hereinafter with reference to the accompanying figures, in which embodiments of the invention are shown. This invention may, however, be embodied in many alternate forms and should not be construed as limited to the embodiments set forth herein.

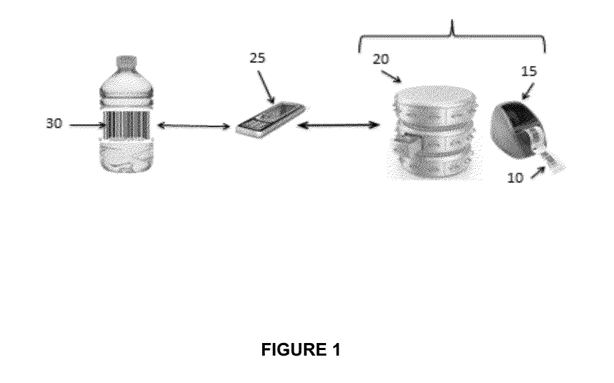

FIG. 1 shows an embodiment of a system, whereby bar code data 10 is generated and printed by generator 15. Bar code data 10 may be stored in product database server 20. Mobile device with mobile application 25 may be used to scan a product's bar code data 30 and communicate with product database server 20. Verification may be sent back to mobile application 25, whereby the user assesses the verification and decides whether or not to make the purchase.

In embodiments, the system may comprise at least one product database server 20, which is/are not particularly limited and may comprise any database server that is suitable to carry out the embodiment. The at least one product database server may be, for example, the latest Windows OS, MS SQL Server, and may be fully patched and HIDS installed. The at least one product database server may comprise the qualities of high-availability and built-in redundancy with the back-end system of the database application using client/server architecture. The back-end system performs tasks such as data analysis, storage, data manipulation, archiving, and other non-user specific tasks.

In embodiments, the system may comprise a mobile application 25 installed on a mobile device, such as a device that operates on mobile platform systems such as iOS or Android. Mobile application 25 may be written in any known language that is suitable to execute the application on a given mobile platform. The mobile application 25 should be written with proper security controls. Mobile application 25 may be distributed to mobile devices through appropriate market location and/or through appropriate media. Mobile application 25 may include other features, such as security features whereby updates may be pushed out automatically to the devices where mobile application 25 is installed. Mobile application 25 may be a signed application to verify the integrity of the written code and the provider. The mobile application 25 may be required to be activated prior to initial use, whereby a unique application activation code may be sent via short messages systems (SMS). Mobile application 25 may be adapted to scan bar code data printed on a product. Mobile application 25 may be adapted to encrypt not only the bar code data but also the basic mobile device information, such as the device's telephone number, location information in the form of coordinates and mobile device owner information such as email or residential addresses. Once encrypted, the bar code data and basic mobile device information are sent over a network to an application server (not shown) which communicates with product database server 20.

In order to maximize security of the encrypted scanned bar code data and basic mobile device information being sent, it may be desirable to send the information over the internet using WiFi so as to avoid telephone companies and other similar carriers.

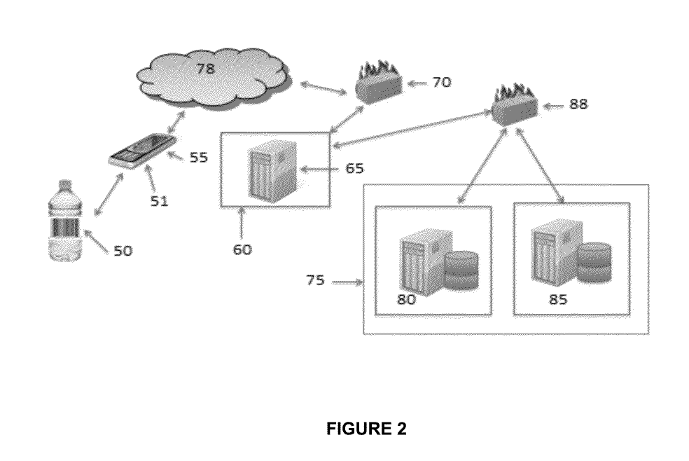

FIG. 2 shows an embodiment of a system, whereby product bar code data 50 is scanned by mobile device 51 with mobile application 55. The scanned bar code data 50 may be sent over internet 78 and transmitted to external network 60 comprising application database server 65. External network 60 may comprise a firewall 70. A query may be sent from the server 65 to internal network 75 comprising a data storage database server 80 and a product database server 85. Internal network 75 may comprise a firewall 88.

In embodiments, the system may comprise at least one application server, which is/are not particularly limited and may comprise any application server that is suitable to carry out the embodiment. The at least one application server may be, for example, the latest Windows OS, and may be fully patched and HIDS installed. The at least one application server may be a program that handles all application operations between purchaser and databases or other backend-type applications. Such an application server is typically used for complex transaction-based applications. To support these needs, the at least one application server may comprise the qualities of built-in redundancy, high-availability, high-performance distributed application services and support for complex database access.

In embodiments, the system may comprise at least one product database server 85, which is/are not particularly limited and may comprise any database server that is suitable to carry out the embodiment. The at least one product database server 85 may be, for example, the latest Windows OS, MS SQL Server, and may be fully patched and HIDS installed. The at least one product database server 85 may comprise the qualities of high-availability and built-in redundancy with the back-end system of the database application using client/server architecture. The back-end system performs tasks such as data analysis, storage, data manipulation, archiving, and other non-user specific tasks.

In embodiments, the system may comprise at least one data storage database server 80, which is/are not particularly limited and may comprise any database server that is suitable to carry out the embodiment. The at least one data storage database 80 server may be, for example, the latest Windows OS, MS SQL Server, and may be fully patched and HIDS installed. The at least one data storage database server 80 may comprise the qualities of high-availability and built-in redundancy with the back-end system of the database application using client/server architecture. The back-end system performs tasks such as data analysis, storage, data manipulation, archiving, and other non-user specific tasks.

In embodiments, the system may comprise a mobile application 55 installed on mobile device 51, such as a device that operates on mobile platform systems such as iOS or Android. Mobile application 55 may be written in any known language that is suitable to execute the application on a given mobile platform. The mobile application 55 should be written with proper security controls. Mobile application 55 may be distributed to mobile devices through appropriate market location and/or through appropriate media. Mobile application 55 may include other features, such as security features whereby updates may be pushed out automatically to the devices where mobile application 55 is installed. Mobile application 55 may be a signed application to verify the integrity of the written code and the provider. The mobile application 55 may be required to be activated prior to initial use, whereby a unique application activation code may be sent via short messages systems (SMS). Mobile application 55 may be adapted to scan bar code data printed on a product. Mobile application 55 may be adapted to encrypt not only the bar code data but also the basic mobile device information, such as the device's telephone number, location information in the form of coordinates and mobile device owner information such as email or residential addresses. Once encrypted, the encrypted scanned bar code data and basic mobile device information are sent over a network to an application server (not shown) which communicates with product database server 85.

In order to maximize security of the encrypted scanned bar code data and basic mobile device information being sent, it may be desirable to send the information over the internet using WiFi so as to avoid telephone companies and other similar carriers.

In embodiments, the system may comprise at least one security feature, which may comprise at least one firewall, encryption technology and/or anti-malware. The at least one firewall may comprise two firewalls 70, 88, wherein one firewall 70 may be disposed before the application server and the other firewall 88 may be disposed between application database server 65 and product database server 85. The encryption technology supports data encryption. This will allow for protection of purchaser and other information while the information is: 1) sent over a network, such as the internet; 2) in rest; and 3) in use. The system may comprise anti-malware on the application and database servers to protect from unwanted software and viruses such as spyware programs.

In embodiments, the system may comprise at least one support desktop (not shown) or other type of central processing unit (not shown) to manage and maintain the application and database servers.

Application database server 65 decrypts and separates the scanned bar code data 50 and basic mobile device information, whereby the mobile device information may be sent to and stored in data storage database server 80. For marketing purposes, data storage database server 80 may be searchable and/or sortable. The decrypted bar code data may be sent to product database server 85 that contains the unique bar code data associated with each product manufactured by a given company or entity, whereby a query may be ran against product database server 85 to determine if product database server 85 contains the unique bar coded data.

In embodiments, the bar code data may be randomly generated and unique bar code data. The bar code data may be generated using an algorithm, such as a GS1 “Data Matrix” algorithm which generates two-dimensional unique and random bar code data. Such bar code data may include comprehensive information and product details. The bar code data may be generated and then stored in product database server 20, 85 and then printed and then affixed to a product. The bar code data is then printed on a label to be affixed to a product's packaging or may be printed directly on the product's packaging. Bar code data scanning software for mobile application 25, 55 for mobile devices may comprise the characteristics such as each download having associated therewith a unique number and requiring a telephone number to receive an activation code for mobile application 25, 55. Such information may be transmitted to product database server 20, 85.

For example, when a genuine product is manufactured at a company's manufacturing facilities, the genuine product is assigned unique and/or random bar code data that is eventually included in the company's product database server prior to the genuine product ending up on the market. The genuine product is then sent off to the market so it can be sold to a customer. Sometime later, a customer desires to purchase the genuine product. The customer goes to the market and identifies what is believed to be the genuine product. To verify, the customer may scan the bar code data of what is believed to be the genuine product, which is sent to a product database server. The system then queries the product database server to determine if the product database server contains the unique bar code data of what is believed to be the genuine product. If the scanned bar code data is present, positive verification may be sent back to customer's mobile device in the form of a SMS message. If the scanned bar code is not present, negative verification may be sent back to customer's mobile device in the form of a SMS message. The mobile application's session may be disconnected once the customer receives the positive or negative verification.

Since many users wills recognize the meaning of “yes” and “no,” regardless of native language, using “yes” or “no” as the verification in binary form may be desired. Colors may also be used for verification, such as green for positive verification and red for negative verification. Languages other than English may be used for the verification.

A customer may download mobile application 25, 55 on a mobile device. In order for mobile application 25, 55 to function, telephone number and/or email address (or other information) may be required for submission. After submission of such information, an enabling code may be sent to the mobile device via SMS to activate mobile application 25, 55. A password may or may not be required. Each application download may have unique coded information which may be collected and transmitted to a data storage database server.

Collected customer information (such as telephone number and email) may be stored in a data storage database server 80, which communicates with product database server 85, and may generate a third database automatically (not shown). Upon scanning a product's bar code data 50, the data 50 may be converted into digital information, encrypted, and pinged against product database server 85 via internet 78. The customer may receive information whether the bar code data matched with product database server 85 or not. If the bar code data is scanned less than 5 times, a green light with “Yes” may appear on mobile application 55. If the same bar code data is pinged more than 5 times, the customer may receive a notice or “warning” with a yellow color. If the same bar code data is pinged more than 10 times, a red light may appear with “No”. If the bar code data is scanned more than 10 times just “by checkers” and the product was not sold, the seller will have an option to send a message to reset according to a particular product (once or twice). When a customer scans a product's bar code data, two queries will be sent out in parallel, the product information with unique application download information number may be sent to application server 60 and the product information will be pinged against product database server 85.

The embodiments described herein are also useful in applications other than counterfeit detection and consumer information, such as in law enforcement and consumer behavior.

If the embodiments described herein detect counterfeit products, the location of the counterfeit products may be obtained by modification of the embodiments to include tracking features. Such tracking features may include longitude and latitude coordinates (via GPS) at the time of scanning a desired product. The law enforcement community may be interested in knowing the origin or location of the point of sale for desired products determined to be counterfeit. Moreover, the commerce community may be interested in statistics related to the origin or location of the point of sale for desired products determined to be counterfeit.

The embodiments described herein may be modified for consumer behavior purposes. For instance, once a desired product is scanned using the embodiments described herein, a coupon may be sent to the consumer's device to influence decision making. The offer of an instant discount or reduction in price in real-time may spur a consumer to purchase a desired product. Also, offers may be sent to a consumer's device that are related to a scanned product. In other words, if a consumer scans product that is a handbag, an offer of an instant discount or reduction in price for a corresponding wallet (that goes with the handbag) may be sent to the consumer's device.

The advertising community may also be interested in the collected customer information (such as telephone number and email). For instance, the aforementioned third database (not shown, generated by communication between data storage database server 80 and product database server 85) may include customer information for customers who purchased, for example, handbags. Adverstisements may then be sent to the consumer's device for handbags and related accessories.

What is claimed is:

1. A system for determining a counterfeit product comprising:
a bar code data scanner and a product database server, wherein the bar code data scanner is adapted to communicate with the product database server, the product database server containing bar code data.

2. The system of claim 1, wherein the bar code data scanner is included in a mobile application on a mobile device, the mobile application adapted for at least one of scanning bar code data, encrypting the data, sending the encrypted data to the product database server, receiving information from the product database server which indicates whether the database server contains the scanned bar code data, providing mobile device location information, providing mobile device information and providing mobile device owner information.

3. The system of claim 2, including:
a first network comprising an application database server that accepts requests from the mobile application and is able to decrypt the encrypted data sent by the mobile application;
a first firewall allowing traffic from the internet to the first network;
a second network comprising the product database server and optionally comprising a data storage database server; and
a second firewall allowing traffic from the application server to the product database and/or the optional data storage database server.

4. The system of claim 2, wherein the product database server is adapted for receiving, storing, searching and sorting bar code data, receiving at least one signal from the mobile application, sending at least one signal to the mobile application, tagging the scanned bar code data as scanned, and moving the scanned bar code data to a different file.

5. The system of claim 3, wherein the system includes the data storage database server, the data storage database adapted for receiving, storing, searching and sorting the mobile device location information, receiving, storing, searching and sorting the mobile device information and receiving, storing, searching and sorting the mobile device owner information.

6. The system of claim 2, wherein the second firewall is adapted to separate bar code data from the mobile device information and send the bar code data to the product database server and send the mobile device information to the data storage database server.

7. A method for determining a counterfeit product comprising:
assigning bar code data to a first product;
storing the bar code data of the first product to a product database server;
scanning with a mobile application bar code data of a second product in a marketplace;
sending the data associated with the scanned bar code data of the second product to the product database;
determining if the bar code data of the first product in the product database server matches the scanned bar code data of the second product in the marketplace.

8. The method of claim 7, including:
generating the bar code data for the first product;
encrypting the scanned bar code data of the second product;
decrypting the scanned bar code data of the second product; and
outputting a signal to the mobile application as to whether the bar code data of the first product in the product database server matches the scanned bar code data of the second product in the marketplace.

9. The method of claim 7, wherein sending the scanned bar code data of the second product to the product database server comprises sending the data over the internet.

10. The method of claim 8, wherein the outputting comprises binary information in the form of yes and no or in colors that correspond to yes and no.

11. The method of claim 1, wherein the bar code data of the first product is unique bar code data and/or randomly generated bar code data.
